(19) United States
(12) Patent Application Publication
(10) Pub. No.: US 2014/0077755 A1
(43) Pub. Date: Mar. 20, 2014

(54) EMERGENCY POWER SUPPLY STARTING SYSTEM FOR A LITHIUM BATTERY WITH AUTOMATIC PREHEATING FUNCTION

(71) Applicants: SHANGHAI POWER STATION CO., LTD., Shanghai (CN); SHANGHAI GUANGWEI ELECTRIC & TOOLS CO., LTD., Shanghai (CN); SHANGHAI GREATWAY TOP POWER CO., LTD., Shanghai (CN)

(72) Inventors: Zhongren Zhang, Shanghai (CN); Zhenming Fan, Shanghai (CN); Ke Li, Shanghai (CN); Qiang Wu, Shanghai (CN); Jing Shen, Shanghai (CN)

(73) Assignees: SHANGHAI POWER STATION CO., LTD., Shanghai (CN); SHANGHAI GREATWAY TOP POWER CO., LTD., Shanghai (CN); SHANGHAI GUANGWEI ELECTRIC & TOOLS CO., LTD., Shanghai (CN)

(21) Appl. No.: 13/836,282

(22) Filed: Mar. 15, 2013

(30) Foreign Application Priority Data
Sep. 20, 2012 (CN) 201210352888.6

(51) Int. Cl. H02J 7/00

(52) U.S. Cl. CPC H02J 7/0029
USPC 320/107

(57) ABSTRACT

An emergency power supply starting system a lithium battery with automatic preheating function, including a lithium battery pack, an output control module, an output module, a working power supply control module, a CPU master control module, an operation panel display function module, a heater control module, a heater module, an information sampling module and a charging module is disclosed. The CPU master control module, monitoring the real-time temperature, residual capacity and user operation status of the lithium battery pack, cuts off all output functions and charges the lithium battery (power supply is resumed only after charging) if the battery voltage is too low; if the voltage is normal but battery temperature is too low, the heater control module will start the heater module to initiate the heating process driven with the low current from the lithium battery and the latter is ready for use after the lithium battery temperature returns to normal. The invention arranges a heating source for heating the lithium battery the invention to realize automatic heating for the lithium battery and therefore, normal usage is possible in low temperature condition.

### CROSS-REFERENCE TO RELATED PATENT APPLICATIONS

This application claims priority to and the benefit of China P.R. Priority Application 201210352888.6, filed Sep. 20, 2012 including the specification, drawings, claims and abstract, is incorporated herein by reference in its entirety.

### TECHNICAL FIELD

The invention is related to technology in the emergency power supply field, particularly to an emergency power supply starting system for a lithium battery with automatic preheating function.

### BACKGROUND OF THE INVENTION

As a successful example of new energy resources, the lithium battery is applied extensively in a plurality of fields. However, due to its stringent demand on temperature conditions it is hard to discharge normal large current in both high and low temperature environments. Discharge performance of a lithium battery falls with decreasing temperature and its discharge performance at low temperature is far from that at room temperature. Generally, its discharging performance at −20° C. is 10%-20% of that at room temperature, and the percentage drastically drops to only 2% at about −30° C. What is worse, the required starting current for common starter of automobile increases as environmental temperature falls. The main environmental condition of an emergency power supply starting product is of low temperature or ultralow temperature, due to its properties, which limits the development of a lithium battery on emergency start-up power. From a user's perspective, it is worthwhile to transfer part of its own energy of the battery into heat energy in a certain process and heat the battery up, which would restore the capacity of the battery of its large current electro-discharge. Take the 8 AH mechanical lithium battery with discharge ratio of 80° C. for example, its discharge current at room temperature is 640 A/5 s/pause of 3 min and it could afford 10 cycles of such a discharge. Thus, its discharge performance is only as weak as about 64 A at a temperature of −20° C., which is not enough to start an automobile. However, if 1 AH or 1.5 AH of it is used to transfer into heat energy for the exchange of the temperature increase of the battery, an ideal discharge performance would be obtained. In spite of some energy loss, the discharge performance is enhanced. Basically, the discharge performance in unit time of such batteries of various capacitance remains the same at the same voltage and same discharge ratio, differing only in discharge time and number of cycles. Thus, this mode of automatic preheat could make up for the innate disadvantage of poor discharge performance of lithium battery at low temperature.

### SUMMARY OF THE INVENTION

The purpose of the invention is to offer an emergency power supply starting system for a lithium battery with automatic preheating function to overcome the disadvantage of poor discharge performance of the lithium battery at low temperature and to improve the startup capability of the lithium battery at low temperature.

The invention is realized with the following technical scheme: the invention includes a lithium battery pack, an output control module, an output module, a working power supply control module, a CPU master control module, an operation panel display function module, a heater control module, a heater module, an information sampling module and a charging module, in which the heater module is disposed on the outside of the lithium battery pack, heating the lithium battery under the control of heater control module, the heater control module, receiving information from the CPU master control module, controls switching on and off of working power supply in the heater module and carries out compulsory power off protection for the heater module on condition of abnormal over current or over-temperature, the working power control module detects usage state, and controls switching on and switching off of power as well as to provide standard working power supply and sampling reference power supply for the CPU master control module, the output control module, connected with the lithium battery pack, controls switching on and switching off the power supply of the lithium battery pack for an external device, the output module, connected with and the under control of the output control module supplies electric power of the lithium battery pack to the external electric device. The information sampling module, connected with the output control module, output module, charging module, working power supply control module, and heater module, respectively collects voltage of the lithium battery pack, external connection status, real-time status in charging process, operation information and real-time temperature information of the lithium battery pack, and transfers the collected information into uniform analog quantity, which is transmitted in time to the CPU master control module. The CPU master control module receives information from the sampling module and executes: processes including estimating real-time residual capacity of lithium battery pack and when abnormal battery voltage change occurs, sending alarm information or compulsory switching off instruction in time, estimating and distinguishing the connection status of a connected external battery apparatus and sending a corresponding instruction or compulsory switching off message when an error occurs, estimating temperature of the lithium battery pack, and on condition of anomaly of battery temperature, raising an alarm or driving the heater control module to start heating and to adjust power of heating and total heating time with reference to the residual capacity of the lithium battery pack, and the charging module is employed to charge the lithium battery pack. The operation panel display function module serves as the input and output window between machine information and user, and submits the user operation information through operation buttons and then displays the processed information from the CPU master control module.

Preferably, the lithium battery pack comprises several individual lithium batteries combined together by means of series connection or combination of series and parallel connection, is employed to provide power supply to an external electric device and provides a working power supply to all the modules in the system.

Preferably, the output control module is a large-current-controlling switch and controls the master switch for an outside power supply.

Preferably, the output module, is an output connecting port, a positive, or a negative port clip, and is employed to fast transmit electric power to an external electric device.

Preferably, the working power supply control module, comprises a power supply electronic switching circuit, a voltage switching control circuit and a reference voltage switching circuit, wherein the power supply electronic switching circuit transfers all operation information to electric signal and automatically turns on the master control circuit switch of the circuit working power supply to transmit voltage of the power supply to voltage switching control circuit by means of a power supply electronic switch, which the power supply electronic switch transfers the battery voltage into working power supply stable enough for CPU master control module, and in the mean time provides working power to voltage switching circuit and takes advantage of voltage switching circuit to provide a reference voltage source with more accuracy as datum reference point of the CPU master control module and provides a working power supply for a temperature measuring and sampling circuit.

Preferably, the CPU master control module is composed of a single-chip and related peripheral circuits.

Preferably, the operation panel display function module comprises a button switch, a digital display module, an LED indicator light and an audio alarm, wherein the button switch provides an input window of user operation, transforms all the operation information of a user, together with information from the information sampling module, into an electric signal, and transfers the information to the CPU master control module, the CPU master control module processes the information and obtains an outcome, and outputs the outcome as a message displayed by the digital display module, as a signal displayed by the LED indicator light, or as an alarm signal of the audio alarm.

Preferably, the heater control module comprises an electronic switch, a fuse wire and a temperature controller, wherein the electronic switch receives instruction from the CPU master control module, and provides power turning on and off for the heater module; the fuse wire and the temperature controller provide double protection to the heater module in operation by turning-off when an abnormal over current or over-temperature occurs in the heater module or the CPU master control module is out of control.

Preferably, the heater module comprises a heater, a heat conduction insulating strip, a temperature fuse wire and a temperature detector, wherein the heater serves as a heat source of the lithium battery pack and transforms electric energy of the lithium battery pack into heat energy through a low current of the lithium battery pack. The heat conduction insulating strip electrically isolates the heater and the lithium battery pack, and in the meantime transmits heat energy evenly to the lithium battery pack. The temperature fuse wire is connected to the heater, and self-runs to turn off power on an abnormally high temperature. The temperature detector is employed to measure the real-time surface temperature of the lithium battery pack, and coordinates with the information sampling module to transform the surface temperature of the CPU master control module into an electric signal, and the electric signal is transmitted to the CPU master control module in real time.

### Detailed Working Principles of the Invention

1. Lithium battery at low temperature could discharge low current in short time, though not large current. Thus, the invention takes advantage of the low current to drive the external heater module, which then increases the temperature of the lithium battery;

2. Heating resistor disc with good stability, connected to positive and negative electrodes of the battery by means of electronic switch, is employed in the external heater and laid out on the surface of each battery in accordance with the shape of the battery. As the low current from the battery goes through the heating resistor disc, it is transferred quickly into heat energy, which heats the surface of the lithium battery through direct conduction. Then the entire temperature is raised back in a short span, so the lithium battery will be at a relative high temperature, and its high discharge capacity restored.

### Working Process of the Invention:

Before the lithium battery starts running, the real-time temperature, residual capacity and user operation status of the lithium battery pack are measured by the CPU master control module and different operations are carried out respectively according to the conditions below.

If voltage is normal but battery temperature is too high, the equipment of the invention will trigger an alarm, and in the mean time compulsorily cut off all input and output functions until the battery is cooled.

If the voltage of the battery is too low, all output function will be compulsorily turned off and restarted after battery charging.

If the voltage is normal but the battery temperature is too low, the heater control module will start the heater module to carry out a heating process with driving of low current from the lithium battery and recover temperature of lithium battery for normal use of consumer.

Compared with Prior Technology, the Invention Enjoys the Following Advantages:

1. The invention could automatically measure real-time temperature and residual capacity and adjust the heating status for lithium according to information detected, which means whether it needs heating or the heating time on different condition.

2. The maximum of heating temperature could be set in the invention to make sure the lithium battery could obtain ideal temperature after the heat process.

3. The maximum of preheating time could be set in the invention to increase heat safety factor of product.

4. The invention could automatically adjust the rate of power and time of preheating according to different environment and different battery capacity.

5. The invention could realize man-machine interaction by transmission of real-time temperature and preheat information to a user through an operation panel.

6. The invention has multiple safety protection and could automatically adjust heating power according to battery temperature, improve heat energy utilization and shorten the preheat latency time. Thus, the operation by a user gets safer, more convenient and more stable.

Above all, the invention has been installed with a heat source for lithium battery heating, cooperating with the control circuit, to automatically heat the lithium battery so that the emergency starting power supply could be used normally in low temperature condition.

### DESCRIPTION OF THE ATTACHED DRAWINGS

FIG. 1 is the system chart of the invention;

FIG. 2 is the working process flow diagram corresponding to the system of the invention;

FIG. 3 is an electric schematic diagram of the working power supply control module circuit in the system of the invention;

FIG. 4 is an electric schematic diagram of the CPU master control module circuit in the system of the invention;

FIG. 5 is an electric schematic diagram of the temperature sampling circuit in the system of the invention;

FIG. 6 is an electric schematic diagram of a USB output and charging control circuit in the system of the invention; and

FIG. 7 is an electric schematic diagram of the heating control circuit in the system of the invention.

### DETAILED DESCRIPTION OF THE PREFERRED EMBODIMENT

The following description of the embodiment is offered with attached drawings and the embodiment below is intended to implement according to the technical scheme of the invention, with detailed execution method and operation processes, but is not to limit the protection scope of the invention.

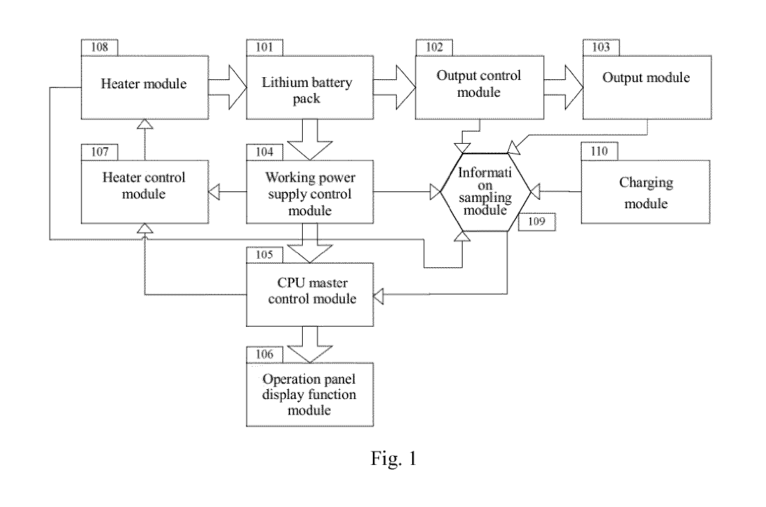

As shown in FIG. 1, the embodiment comprises: lithium battery pack 101, output control module 102, output module 103, working power supply control module 104, CPU master control module 105, operation panel display function module 106, heater control module 107, heater module 108, information sampling module 109 and charging module 110, in which:

The heater module is disposed on the outside of the lithium battery pack, heating the lithium battery under the control of heater control module.

The heater control module, receiving information from the CPU master control module, controls switching on and off of working power supply in the heater module and carries out compulsory power off protection for the heater module on condition in the event of abnormal over current or over-temperature.

The working power control module detects usage state, controls switching on and off of power as well as provide standard working power supply and sampling reference power supply for the CPU master control module.

The output control module, connected with the lithium battery pack, controls the switch of power supply of the lithium battery pack for external device.

The output module, connected with and under control of output control module, supplies electric power of lithium to the external electric device.

The information sampling module, connected with the output control module, output module, charging module, working power supply control module, and heater module, respectively collects information including the voltage of the lithium battery pack, external connection status, real-time status in charging process, operation information and real-time temperature information of the lithium battery pack, and transfers the collected information into uniform analog quantity, which is transmitted in time to the CPU master control module;

The CPU master control module receives information from the sampling module and executes steps including estimating real-time residual capacity of lithium battery pack and when abnormal battery voltage change occurs, sending alarm information or compulsory switching off instruction in time, estimating and distinguishing the connection status of a connected external battery apparatus and sending a corresponding instruction or compulsory switching off message when an error occurs, estimating the temperature of the lithium battery pack, and on condition of anomaly of battery temperature, raising an alarm or driving the heater control module to start heating and to adjust the power of heating and total heating time with reference to the residual capacity of the lithium battery pack.

The charging module is employed to charge the lithium battery pack.

The operation panel display function module serves as the input and output window between machine information and the user, submits the user operation information through operation buttons and then displays the processed information from the CPU master control module.

In one embodiment, the lithium battery pack comprises several individual lithium batteries combined together by means of a series connection or combination of series and parallel connection, has functions 1. to provide power supply to an external electric device; and 2. to provide working power supply to the inner control circuit;

In one embodiment, the output control module, comprises a large-current-controlling switch and output wires, and controls for the master switch for the outside power supply.

In one embodiment, the output module, comprises output wires, an output connecting port, and/or a positive, or a negative port clip, and functions mainly to establish a fast connection between the battery and an external electric device by means of the output system.

In one embodiment, the working power supply control module comprises a power supply electronic switching circuit, a voltage switching control circuit and a reference voltage switching circuit, wherein the power supply electronic switching circuit transfers all operation information to an electric signal and automatically turns on the master control circuit switch of the circuit working power supply to transmit voltage of the power supply to the voltage switching control circuit by means of the power supply electronic switch, the voltage switching control circuit transfers the battery voltage into stable working power supply required of the CPU master control module, and in the mean time provides working power to the reference voltage switching circuit, and by means of the latter provides a reference voltage source with more accuracy to serve as a reference point for the CPU master control module and a working power supply for the temperature measuring and sampling circuit.

In one embodiment, the CPU master control module is composed of a single-chip and related peripheral circuits.

In one embodiment, the operation panel display function module comprises a button switch, a digital display module, an LED indicator light and an audio alarm. The button switch provides an input window of user operation, transforms all the operation information of a user together with information from the information sampling module into an electric signal, and transfers the information to the CPU master control module. The CPU master control module processes the information and obtains an outcome, and outputs the outcome as a message displayed by the digital display module, as a signal displayed by the LED indicator light, or as an alarm signal of the audio alarm.

In one embodiment, the heater control module comprises an electronic switch, a fuse wire and a temperature controller, wherein the electronic switch receives instruction from the CPU master control module, and provides power turning on and off for the heater module; the fuse wire and the temperature controller provide double working protection to the heater module by turning-off when an abnormal over current or over-temperature occurs in the heater module or the CPU master control module is out of control.

In one embodiment, the heater module, being a core component of the system, comprises a heater, a heat conduction insulating strip, a temperature fuse wire and a temperature detector, wherein the heater serves as a heat source of the lithium battery pack and transforms electric energy of the lithium battery pack into heat energy through a low current of the lithium battery pack. The heat conduction insulating strip electrically isolates the heater and the lithium battery pack, and in the meantime transmits heat energy evenly to the lithium battery pack. The temperature fuse wire is connected to the heater, and self-runs to turn off power on an abnormally high temperature. The temperature detector is employed to measure the real-time surface temperature of the lithium battery pack, and coordinates with the information sampling module to transform the surface temperature of the CPU master control module into an electric signal, and the electric signal is transmitted to the CPU master control module in real time.

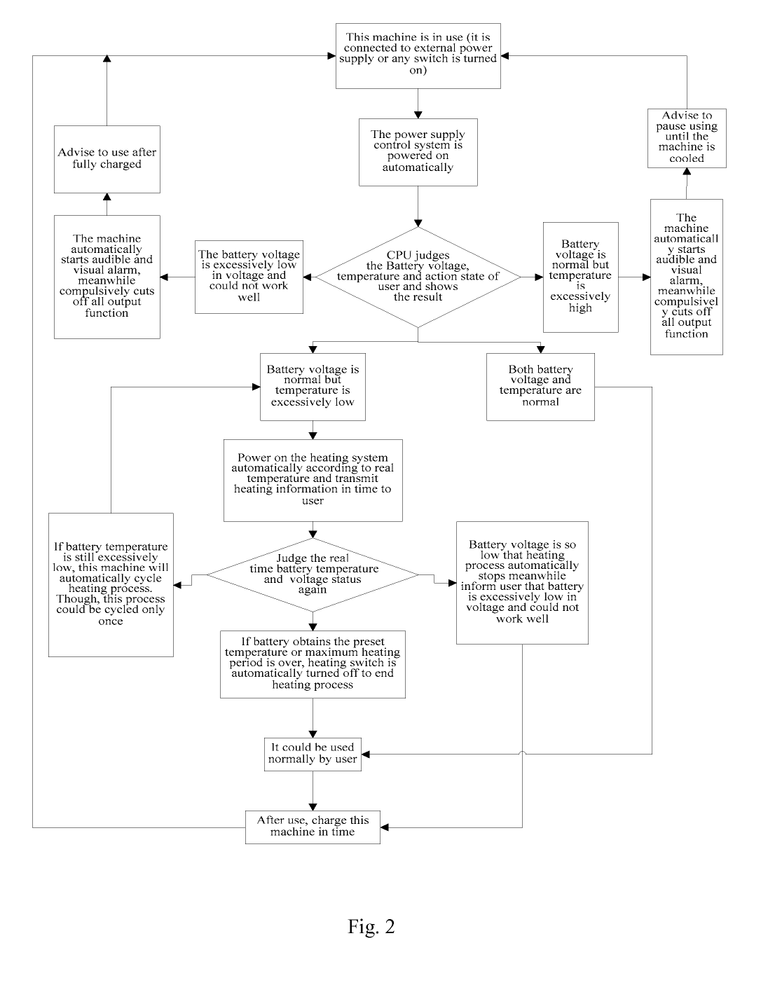

As shown in FIG. 2, the working process of the invention is described below:

Before the lithium battery starts running, the real-time temperature, residual capacity and user operation status of the lithium battery pack are measured by the CPU master control module and different operations are carried out respectively according to the conditions below:

If the voltage is normal but battery temperature is excessive, the equipment of the invention will give off an alarm, and in the mean time compulsorily cut off all input and output functions until it is cooled;

If the voltage of battery is too low, all output function will be compulsorily turned off and restarted after battery charging;

If the voltage is normal but battery temperature is too low, the heater control module will start the heater module to carry out a heating process by driving low current from the lithium battery and recover the temperature of lithium battery for normal use by the consumer.

As shown in FIG. 2, the detailed working process of the embodiment is described below:

Before the lithium battery starts running, the real-time temperature, residual capacity and user operation status of the lithium battery pack are measured by the CPU master control module and different operations are carried out respectively according to the conditions below:

If the voltage is normal but battery temperature is too high, the equipment of the invention will give off an alarm, and in the mean time compulsorily cut off all input and output functions until it is cooled;

If the voltage of battery is too low, all output function will be compulsorily turned off and restarted after battery charging;

If the voltage is normal but battery temperature is too low, heater control module will start the heater module to carry out a heating process by driving low current from the lithium battery and recover the temperature of the lithium battery for normal use of consumer.

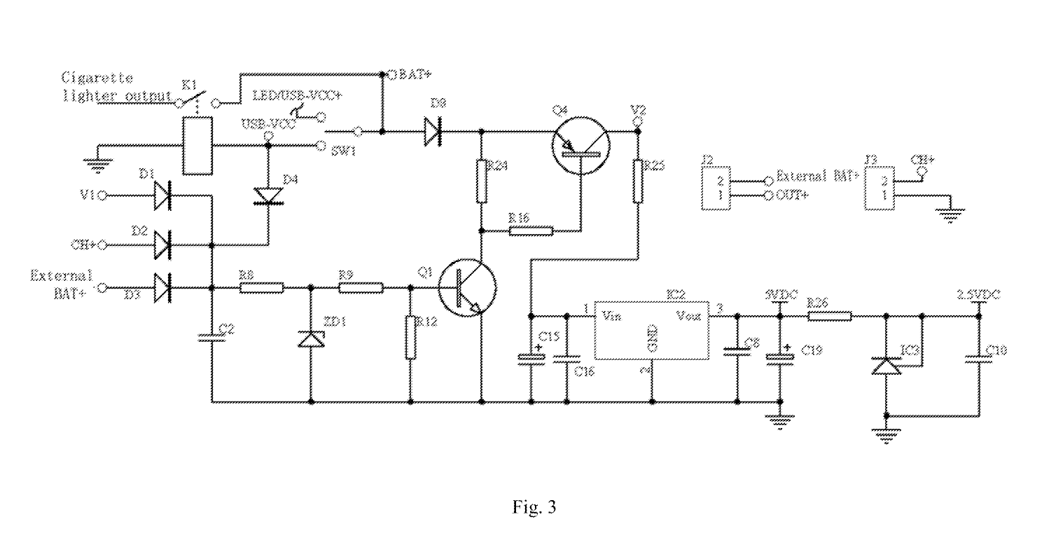

As shown in FIGS. 3-7, the fundamental diagram of the circuit corresponding to the embodiment is described below:

FIG. 3 shows a circuit diagram of the power supply control circuit. When switch SW1 is changed from OFF position to USB-VCC position, voltage of positive port BAT+ will pass the switch, be limited by diode D4, current-limiting resistance R8 and voltage-regulator diode ZD1 and then pass current-limiting resistance R9 to drive switch tube Q1 so as to completely allow current flow in Q1. Thus, the Q4 base electrode could obtain reversal bias voltage and the Q4 switch tube completely allow current to flow; voltage of positive port BAT+, passing through diode D8, Q4 and R25, enters into the input end of the three-port integrated voltage stabilizer 7805 so that port 3 provides stable 5 VDC voltage power to the CPU and other circuits. The 5 VDC voltage passes through current-limiting resistance R26 and enters into IC3, so that IC3 could provide stable 2.5V power to CPU and temperature detecting circuit as a reference voltage source.

When any port of “V1”, “CH+”, “external VCC” and so on is powered on, 7805 then will turn into normal working status. Among these ports, if “V1” is inversely connected with an external clip, the external reverse connection signal will be transferred through IC5 into an inner positive signal, which will be transmitted to the input port of diode D1.

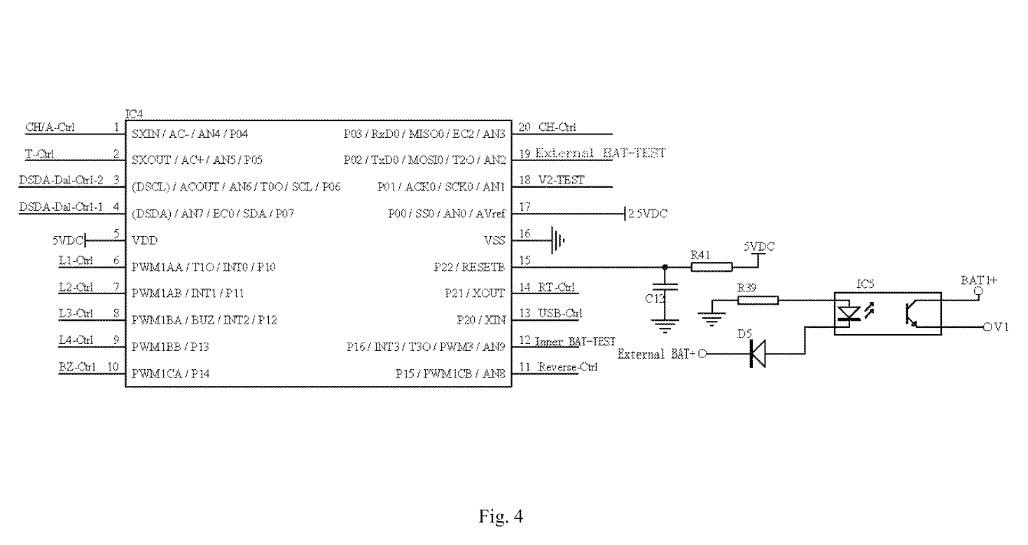

As is shown in FIG. 4, a diagram of the master control circuit, after the CPU is powered on, it will automatically detect the AD variation of all signal input ports, which is then calculated and processed to drive the corresponding opto-acoustic alarm control circuit and the heater switch control circuit.

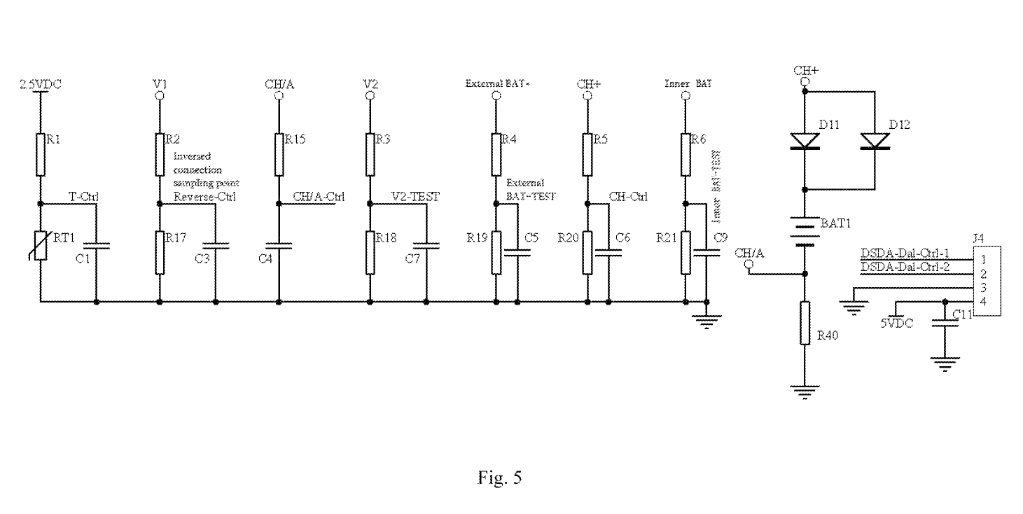

As is shown in FIG. 5, a circuit diagram for battery temperature sampling, the battery temperature sampling resistance composes R1 and RT1, wherein RT1 is an NTC high-precision thermistor, processed and disposed on the surface of the battery housing. After the CPU is powered on, different voltage drop is generated by RT1 in accordance with different resistance value responding to the battery surface temperature, and a corresponding electric signal enters into the port 11 of the single-chip. The signal processed by the single-chip represents the real time temperature, so that the temperature state of the battery could be judged to be normal, too high or too low respectively. If over-temperature occurs, an opto-acoustic alarm will ring in time; if the battery temperature is too low, an alarm will be set by flickering of the LED and the battery is heated according to the actual temperature; when heating time is over or it has reached the preset temperature, the heating process will automatically stop, and in the mean time the flickering of the LED as an alarm will go off to show the end of heating and start of a standby mode.

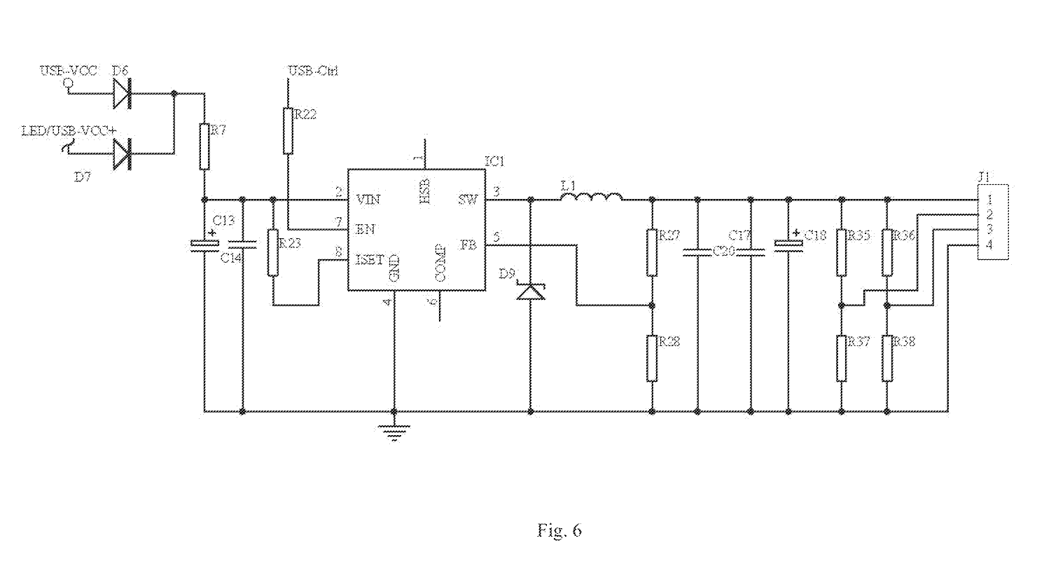

The inversed connected alarm signal sampling circuit is composed of IC5, R39, D5 and R2, R17 as well as C3. Its specific working process is described as below: the large current switch is positioned at OFF, the positive electrode clip of the machine is connected to the negative electrode of the external battery, and the negative electrode clip of the machine is connected to the positive electrode of the external battery. Then, the voltage of the external battery is current-limited by R39, and then transferred into an optical signal by IC5 and D5, and turned back into an electric signal by IC5. The electric signal is divided by port3 of IC5 into two parts, one of which is transmitted into the power supply control circuit to start the working power supply and the other one is connected to R2, R17, C3 and so on, so that the signal is input into the single-chip to be processed. The circuit diagram of the USB output and charging control is shown in FIG. 6.

In the sampling circuit, the “CH/A” serves as a sample of the charging current intensity; “V2” as a sample of the working status of the inner battery; the “external BAT+” as a sample of correctness of the external battery polarity of output clip, and in the mean time as a sample of misconnection of the external battery (for example, a machine of 12V is connected to both ends of battery of 24V, which indicates misconnection of the inner and external batteries); the “CH+” as a sample of the input voltage of the charger to judge whether there is charging voltage input. If there is, the corresponding charging indicating circuit will be powered on to transmit real-time charging status to the user by an LED; the “inner BAT”″ as sampling site of the electric quantity of the inner battery. The power supply and “BSB-VCC” is connected to the same terminal and the real-time residual capacity of the battery is indicated with LED lights of various colors.

After switch SW1 is turned on, the power supply control chip IC 1 is powered on and connected to the USB port through the peripheral sampling, voltage reduction, voltage stabilization, filtration circuits, and so on. Meanwhile, the CPU is powered on and starts to function. If voltage of the inner battery is lower than the set value, the 11 port of single-chip will output a low current, so that IC1 will cut off output. Thus, the function of USB to automatically cut off on condition of low voltage is realized.

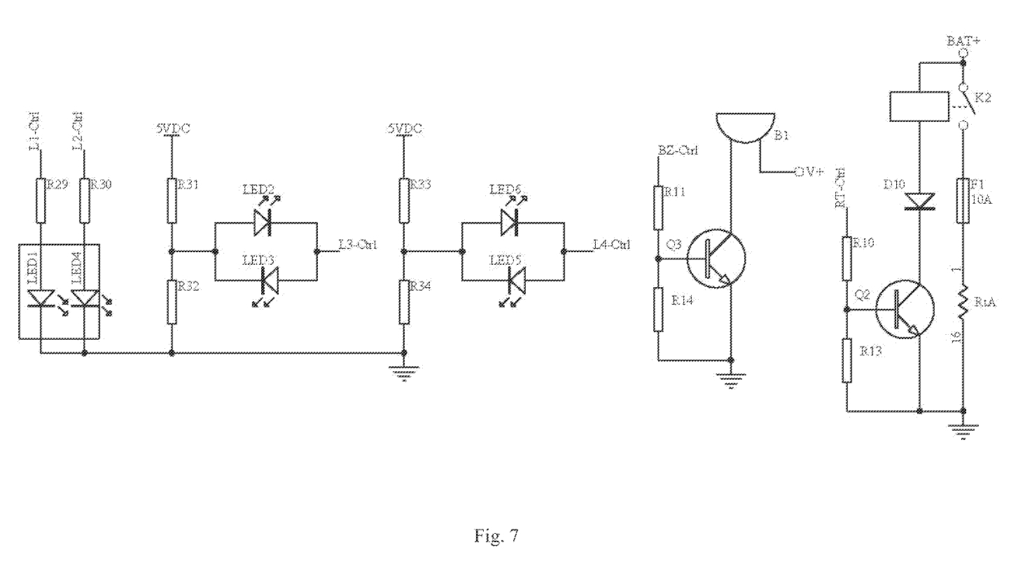

FIG. 7 shows a diagram of the heating control circuit and the heating circuit, wherein, LED1 and LED4 serve as indications of connection status of the machine with the external device. When it is connected correctly, LED4 (green light) will light up; when the external connection is in reverse, LED1 will fast blink (0.25 s on/0.25 s off) and beep with a continuous alarm. If voltage of the external battery is incorrect, LED1 will slowly blink (1 s on/1 s off) and beep with a continuous alarm to indicate a misconnection of the inner and external batteries.

LED2, LED5 and LED6 serve as indications of battery electric quantity and rolling flicker indications for charging. When the battery voltage is lower than 11.5V, the LED2 (red light) will light up; when it is higher than 11.5V but less than 12.5V, LED6 (yellow light) will light up; when it is higher than 12.5V but lower than 15.5V, LED5 (green light) will light up; when it is higher than 15.5V, LED5 will fast blink and beep with a continuous alarm. When the charger is connected and the battery is in charging status, LED2, LED5 and LED6 will automatically light in rolling cycle, which indicates that it is being charged. When the charging of battery is over, LED2, LED5 and LED6 will be all in constant light-up status, which indicates that the battery is fully charged.

LED3 serves as an indicator of the battery temperature. When battery temperature is over 60° C., LED3 (red light) will light up and sound an alarm continuously; when battery temperature is too low, the machine will heat the battery automatically after the system is powered on, and in the mean time LED3 will flicker (0.5 s on/0.5 s off), which indicates that the battery temperature is too low and the machine is in the heating process. When the heating process is over or battery temperature is in the normal range, LED3 goes off automatically.

The sound alarm circuit is composed of the beeper B1, the control switch tube Q3 and the resistors R11, R14. The battery heating system is composed of an electrical relay K2, a resettable fuse RF1, a heating resistor disc RtA, a protection diode D10, a switch tube Q2 and resistors R10, R13. When the single-chip decides that battery temperature is too low and the battery needs heating, the 13 port of the single-chip will output a high level current to drive the switch Q2 to be powered on, so that the electrical relay K2 is in pull-in break-over status and the heating resistor disc obtains working power supply. Thus, the objective to heat the lithium battery is realized.

In one embodiment, the specific standards of control is described as below:

1. The system automatically adjusts the total heating time and pause recovery time according to the real time condition of battery. Corresponding to different battery temperatures, the heating time could be 3 min, 5 min or 10 min. If battery temperature is −5° C.˜-10° C., the total heating time should be 3 min; if −10° C.˜-20° C., it is 5 min; if less than −20° C., it is 10 min, and in the mean time, there is two heating cycles per min (it means a cycle includes heating of 27 s and pause of 3 s). Thus, the battery could be quickly heated up, and in the mean time is protected timely and has time for automatic recovery;

2. Relevant parameter setting of the heating system: upper limit of battery temperature (60° C.), upper limit of maximum heating temperature (20° C.), heating start temperature point (−5° C.), continuous heating up time 27 s (subject to the real-time voltage of the battery), pause period 3 s, longest heating up time 3 min, 5 min and 10 min (automatically adjusted according to the actual battery temperature);

In one embodiment, the heating resistor chip could serve as a heat source for the battery, as well as in the role of increasing the thermal dissipation area of the battery surface to help cooling the battery.

One embodiment fully takes advantage of the energy of the battery itself to realize automatic detection of the battery voltage, temperature and a series of actions such as heating, cutting off and so on at ultralow temperature, and the capacity of the battery to output large current at ultralow temperature.

The fundamental mechanism, main characters and advantages of the invention are described and shown above. A person of the art should be aware that the invention is not limited by the embodiment above. Contents described in the above embodiment and specifications are intended to illustrate mechanisms of the invention. Various changes and modifications may be made to the embodiment without departing from the spirit and scope of the invention, which are all included in the scope of protection of the invention. The scope of the invention is to be limited only by the appended claims and its equivalents.

1. An emergency power supply starting system for a lithium battery with automatic preheating function, comprising a lithium battery, an output control module, an output module, a working power supply control module, a CPU master control module, an operation panel display function module, a heater control module, a heater module, an information sampling module and a charging module, wherein:
the heater module is disposed on the outside of the lithium battery for heating the lithium battery under the control of the heater control module;
the heater control module, receives information from the CPU master control module, to control switching on and switching off of a working power supply in the heater module and implements compulsory power off protection for the heater module when abnormal over current or over-temperature occurs;
the working power control module detects usage status, controls switching on and switching off of power and provides standard working power supply and sampling reference power supply for the CPU master control module;
the output control module is connected with the lithium battery, and controls the switching on and switching off of the power supply of the lithium battery for an external device;
the output module is connected with and under control of the output control module, and supplies electric power of the lithium battery to an external electric device;
the information sampling module is connected with the output control module, the output module, the charging module, the working power supply control module, the heater module, and respectively collects voltage of the lithium battery, external connection status, real-time status in charging process, user operation information and real-time temperature information of the lithium battery, and transfers the collected information into uniform analog quantity, which is transmitted in time to the CPU master control module;
the CPU master control module receives information from the sampling module and executes estimating real-time residual capacity of the lithium battery and when abnormal battery voltage change occurs, sending alarm information or compulsory switching off instruction in time, estimating and distinguishing the connection status of a connected external battery apparatus and sending a corresponding instruction or a compulsory switching off message when an error occurs, estimating temperature of the lithium battery, and on condition of anomaly of battery temperature, raising an alarm or driving the heater control module to start heating, and adjusting power of heating and total heating time with reference to the residual capacity of the lithium battery;
the charging module is employed to charge the lithium battery; and
the operation panel display function module serves as the input and output window between machine information and a user, and submits the user operation information by means of operation buttons and then displays the processed information from the CPU master control module.

2. An emergency power supply starting system for a lithium battery with automatic preheating function according to claim 1, wherein the lithium battery comprises a plurality of individual lithium batteries combined together by means of at least one of a series connection or a combination of series and parallel connections, and is employed to provide power supply to an external electric device and to provide working power supply to all the modules in the system.

3. An emergency power supply starting system for a lithium battery with automatic preheating function according to claim 1, wherein the output control module is a large-current-controlling switch and controls the master switch for the outside power supply.

4. An emergency power supply starting system for a lithium battery with automatic preheating function according to claim 1, wherein the output module comprises an output connecting port, a positive, or a negative port clip, and is employed to fast transmit electric power to an external electric device.

5. An emergency power supply starting system for a lithium battery with automatic preheating function according to claim 1, wherein the working power supply control module comprises a power supply electronic switching circuit, a voltage switching control circuit and a reference voltage switching circuit, wherein the power supply electronic switching circuit transfers all user operation information to electric signal and automatically turns on the master control circuit switch of the circuit working power supply to transmit voltage of power supply to voltage switching control circuit by means of the power supply electronic switch, the power supply electronic switch transfers the battery voltage into working power supply stable enough for the CPU master control module, and in the meantime provides working power to the voltage switching circuit and the voltage switching circuit provides a reference voltage source with more accuracy as data reference point of the CPU master control module and provides a working power supply for a temperature measuring and sampling circuit.

6. An emergency power supply starting system for a lithium battery with automatic preheating function according to claim 1, wherein the operation panel display function module comprises a button switch, a digital display module, an LED indicator light and an audio alarm, wherein the button switch provides an input window of user operation, transforms all the user operation information, together with information from the information sampling module, into electric signal, and transfers the information to the CPU master control module, the CPU master control module processes the information and obtains an outcome, and outputs the outcome as at least one of a message displayed by the digital display module, a signal displayed by the LED indicator light, or an alarm signal of the audio alarm.

7. An emergency power supply starting system for a lithium battery with automatic preheating function according to claim 1, wherein the heater control module comprises an electronic switch, a fuse wire and a temperature controller, wherein the electronic switch receives instruction from the CPU master control module, and provides power turning on and off for the heater module; the fuse wire and the temperature controller provide double protection to the heater module in operation by turning-off when at least one of an abnormal over current or over-temperature occurs in the heater module or the CPU master control module is out of control.

8. An emergency power supply starting system for a lithium battery pack with automatic preheating function according to claim 1, characterized in that wherein the heater module comprises a heater, a heat conduction insulating strip, a temperature fuse wire and a temperature detector, wherein the heater serves as a heat source of the lithium battery pack and transforms electric energy of the lithium battery pack into heat energy through a low current of the lithium battery pack, the heat conduction insulating strip electrically isolates the heater and the lithium battery pack, and in the meantime transmits heat energy evenly to the lithium battery pack, the temperature fuse wire is connected to the heater, and self-runs to turn off power on an abnormally high temperatures, the temperature detector is employed to measure the real-time surface temperature of the lithium battery pack, and coordinates with the information sampling module to transform the surface temperature of the CPU master control module into an electric signal, and the electric signal is transmitted to the CPU master control module in real time.
